(19) United States
(12) Patent Application Publication
(10) Pub. No.: US 2014/0030626 A1
(43) Pub. Date: Jan. 30, 2014

(54) SOLID OXIDE FUEL CELL

(71) Applicant: SAMSUNG SDI CO., LTD., Yongin-si (KR)

(72) Inventors: Hyun Soh, Yongin-si (KR); Jan-Dee Kim, Yongin-si (KR); Sang-Jun Kong, Yongin-si (KR)

(73) Assignee: SAMSUNG SDI CO., LTD., Yongin-si (KR)

(21) Appl. No.: 13/794,724

(22) Filed: Mar. 11, 2013

(30) Foreign Application Priority Data
Jul. 24, 2012 (KR) 10-2012-0080602

(51) Int. Cl. H01M 8/02

(52) U.S. Cl. CPC H01M 8/0202
USPC 429/468; 429/452

(57) ABSTRACT

A solid oxide fuel cell (SOFC) includes a plurality of cylindrical unit cells and a current collecting member. Each unit cell has a first electrode, a second electrode provided to an outside of the second electrode, and an electrolyte interposed between the first and second electrodes. The current collecting member electrically connects the unit cells. In the SOFC, the current collecting member is composed of a plurality of layers, and the layers have different voids from one another.

### CROSS-REFERENCE TO RELATED APPLICATION

This application claims priority to and the benefit of Korean Patent Application No. 10-2012-0080602, filed on Jul. 24, 2012, in the Korean Intellectual Property Office, the entire content of which is incorporated herein by reference.

### BACKGROUND

1. Field

An aspect of the present invention relates to a solid oxide fuel cell (SOFC), and more particularly, to an SOFC having improved current collecting efficiency.

2. Description of the Related Art

Fuel cells utilize a high-efficiency, clean generation technology for directly converting hydrogen and oxygen into electric energy through an electrochemical reaction. Here, the hydrogen is contained in hydrocarbon such as natural gas, coal gas or methanol, and the oxygen is contained in the air. Such fuel cells are classified into alkaline fuel cells, phosphoric acid fuel cells, molten carbonate fuel cells, solid oxide fuel cells and polymer electrolyte membrane fuel cells, depending on the kind of an electrolyte used.

Among these fuel cells, a solid oxide fuel cell (SOFC) is a fuel cell operated at a high temperature of about 600 to 1000° C. The SOFC has the highest efficiency and the lowest pollution as compared with other kinds of SOFCs. The SOFC does not require a fuel reformer, and enables complex power generation.

Since such a SOFC has low voltage, the SOFC is used in a stack configured by connecting a plurality of unit cells so as to obtain a suitable high voltage. In this case, the unit cells may be electrically connected to one another using a current collecting member or the like, and various studies have been conducted to improve electrical efficiency between the unit cells through the current collecting member.

### SUMMARY

Aspects of embodiments are directed toward a structure of a solid oxide fuel cell (SOFC) having improved electrical efficiency between a plurality of unit cells.

Aspects of embodiments are also directed toward an SOFC including a novel current collecting member.

Aspects of embodiments are also directed toward an SOFC in which the voltage drop at a high temperature does not occur.

According to an embodiment of the present invention, an SOFC is provided to include: a plurality of cylindrical unit cells each having a first electrode, a second electrode provided to an outside of the second electrode, and an electrolyte interposed between the first and second electrodes; and a current collecting member that electrically connects the unit cells, wherein the current collecting member is composed of a plurality of layers, and the layers have different voids from one another.

The unit cells may be composed of first groups each having one or more of the unit cells arranged in parallel in a first direction, and the first groups may be stacked to form a plurality of layers.

The current collecting member may be interposed between adjacent ones of the first groups in the plurality of layers.

The first electrode may include an anode and the second electrode may include a cathode. The current collecting member may be provided with a layer having a low pore number per inch (ppi) at a portion of the current collecting member contacting the second electrode.

The ppi of the current collecting member may be 20 to 60%.

The current collecting member may include first to third current collecting layers which are sequentially laminated, and the first current collecting layer may be provided to come in contact with the second electrode.

The ppi of the first current collecting layer may be no less than 20% to less than 30%, the ppi of the second current collecting layer may be no less than 30% to less than 50%, and the ppi of the third current collecting layer may be no less than 50% to no more than 60%.

With respect to the external diameter a of the unit cell, the thickness of the first current collecting layer may be 0.5a to 1.2a, the thickness of the second current collecting layer may be 1.0a to 0.5a, and the thickness of the third current collecting layer may be 0.1a to 0.5a.

The length of the unit cell may be no less than 50 cm, and the section of the unit cell may be circular.

As described above, according to embodiments of the present invention, it is possible to provide an SOFC having improved electrical efficiency between a plurality of unit cells.

Further, it is possible to provide an SOFC including a novel current collecting member.

Further, it is possible to provide an SOFC in which the voltage drop at a high temperature does not occur.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a perspective view of a solid oxide fuel cell (SOFC) according to an embodiment of the present invention.

FIG. 2 is an exploded perspective view of the SOFC of FIG. 1.

FIG. 3A is a sectional view taken along line X-X′ of the SOFC of FIG. 1.

FIG. 3B is a scanning electron microscope (SEM) photograph of a current collecting member of FIG. 3A.

FIG. 4 is a graph showing voltage drop according to pore number per inch (ppi) and current.

FIG. 5 is a graph showing air permeability according to ppi.

FIG. 6 is a sectional view of an SOFC according to an embodiment of the present invention.

FIG. 7 is an SEM photograph of a current collecting member of FIG. 6.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the other element or be indirectly on the other element with one or more intervening elements interposed therebetween. Also, when an element is referred to as being “connected to” another element, it can be directly connected to the other element or be indirectly connected to the other element with one or more intervening elements interposed therebetween. Hereinafter, like reference numerals refer to like elements. In the drawings, the thickness or size of layers may be exaggerated for clarity and not necessarily drawn to scale.

Hereinafter, as an example, an embodiment of the present invention will be described with reference to the accompanying drawings.

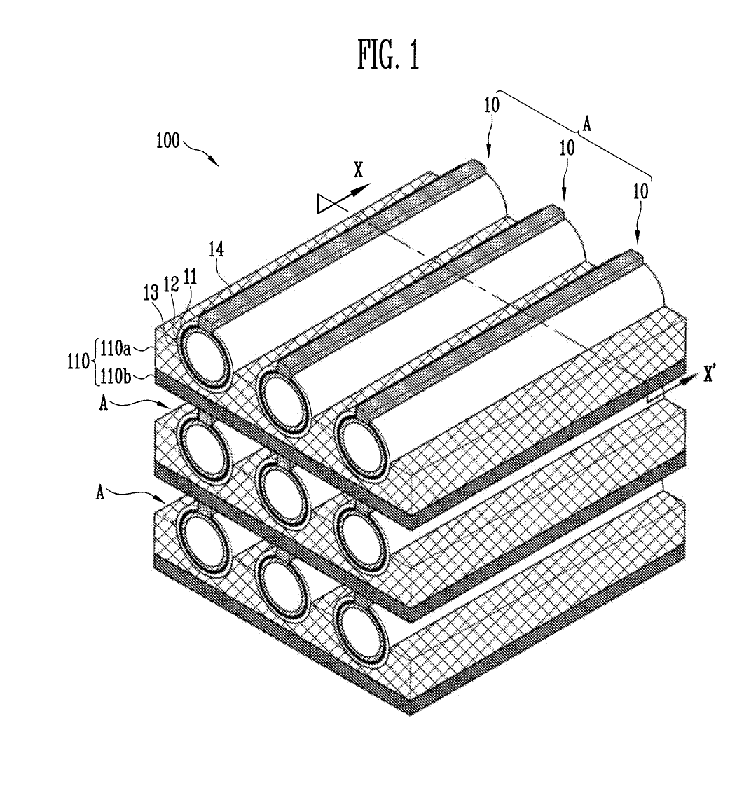

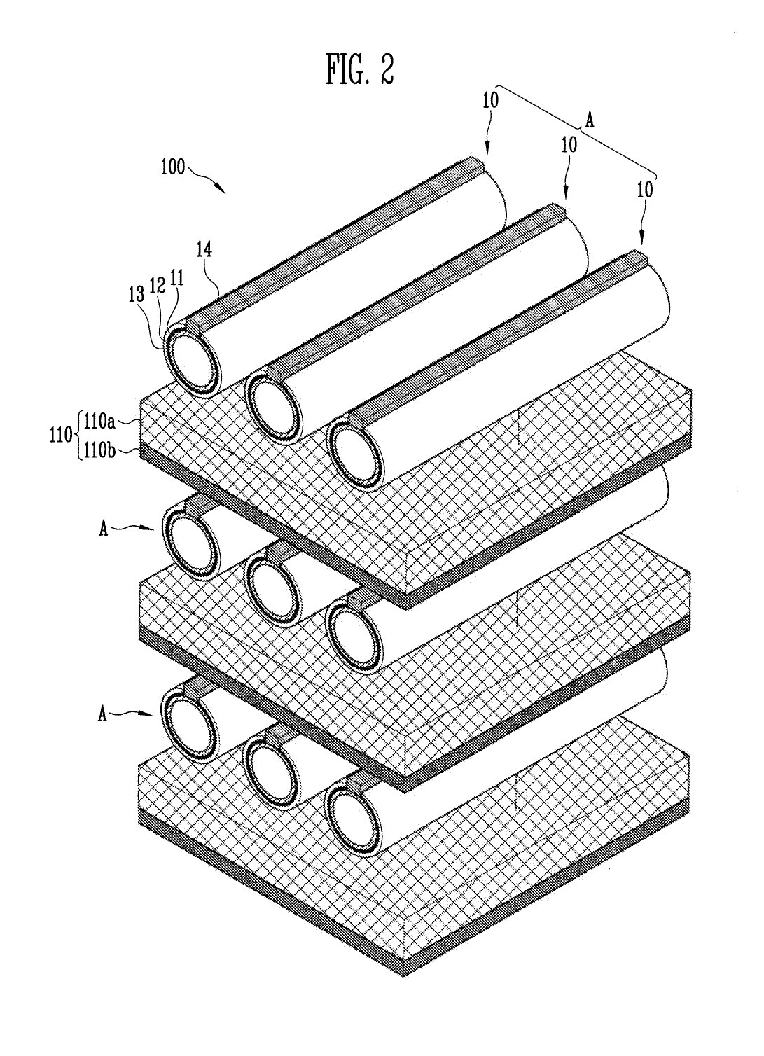

FIG. 1 is a perspective view of a solid oxide fuel cell (SOFC) according to an embodiment of the present invention. FIG. 2 is an exploded perspective view of the SOFC of FIG. 1.

The SOFC 100 according to this embodiment includes a plurality of cylindrical unit cells 10 each having a first electrode 11, a second electrode 13 provided to the outside of the first electrode 11, and an electrolyte 12 interposed between the first and second electrodes 11 and 13; and a current collecting member 110 that electrically connects the unit cells 10. The current collecting member 110 is composed of one or more layers 110a and 110b, and the layers 110a and 110b are provided to have different voids from each other.

The unit cell 10 is formed in the shape of a cylinder having a hollow formed therein, and may be provided by sequentially laminating the first electrode 11, the electrolyte 12 and the second electrode 13 from the inside of the unit cell 10. The unit cell may be provided with an interconnector 14, and the interconnector 14 may be connected to the first electrode 11 so as to have the same polarity as the first electrode. The unit cell 10 causes the movement of current (or charges) by electrochemically reacting hydrogen supplied through the first electrode 11 and oxygen supplied through the second electrode 12 at the medium of the electrolyte 12.

In the SOFC configured as described above, hydrogen is supplied into the hollow formed in the unit cell 10. Here, the hydrogen loses an electron in the first electrode 11 and becomes a hydrogen ion. Subsequently, the electron lost by the hydrogen in the first electrode 11 moves to the second electrode 13 of an adjacent unit cell 10 through the current collecting member 110 contacting the interconnector 14 via the interconnector 14. Here, the electron ionizes an oxygen molecule. Then, oxygen ions in the second electrode 13 move to the adjacent first electrode 11 through the electrolyte 12 and then react with the hydrogen ion, thereby completing a fuel cell reaction while forming water. As such, the plurality of unit cells 10 generate current by continuously causing the reaction described above.

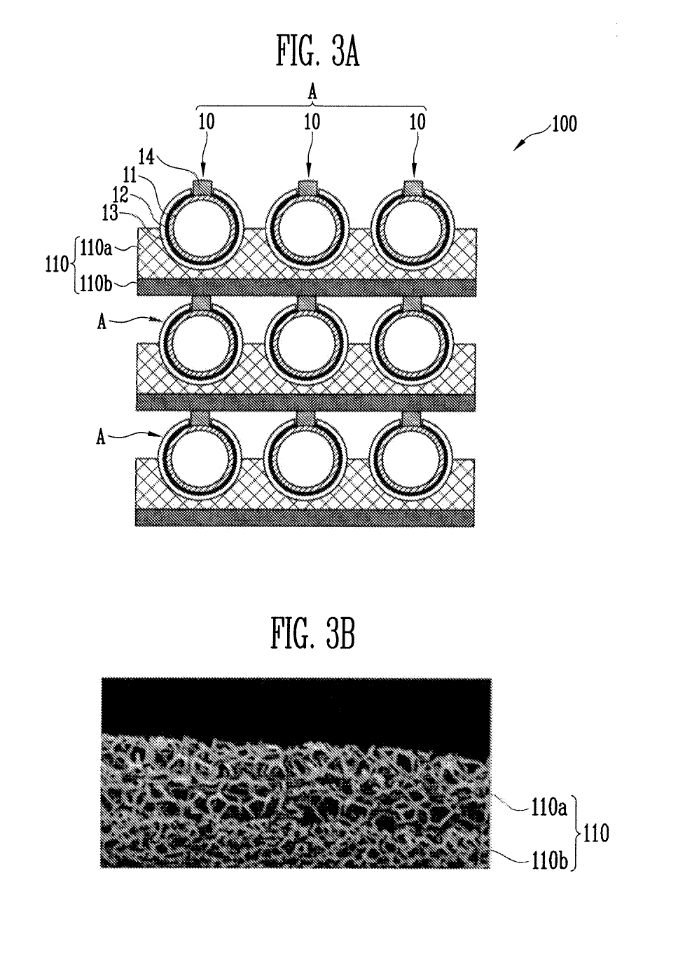

FIG. 3A is a sectional view taken along line X-X′ of the SOFC of FIG. 1. FIG. 3B is a scanning electron microscope (SEM) photograph of a current collecting member according to the embodiment of the present invention.

Referring to FIGS. 3A and 3B, the unit cells 10 may be composed of first groups A each including one or more unit cells 10 arranged in parallel in a first direction, and the first groups A may be stacked to form a plurality of layers. The current collecting member 110 may be interposed between the first groups A adjacent to each other in the plurality of layers.

Generally, a SOFC can have various shapes for electrically connecting unit cells according to geometrical properties. For example, a cylindrical SOFC may be either a cylindrical SOFC formed by winding a current collecting member around the outside of each unit cell or a cylindrical SOFC formed by providing an interconnector to each unit cell and then connecting the unit cells using a current collecting member. In the cylindrical SOFC having the interconnector, electrons move from a first electrode of one unit cell to a second electrode of another unit cell adjacent to the one unit cell through a path using the interconnector. The electrons moving as described above cause a voltage drop due to the path, and therefore, the energy efficiency of the SOFC is deteriorated. Particularly, the energy efficiency of the SOFC is seriously deteriorated at a high temperature, and the voltage drop increases as the amount of current increases.

An embodiment of the present invention relates to a cylindrical SOFC having an interconnector, which improves energy efficiency using a novel current collecting member. The SOFC can reduce or minimize a voltage drop by improving the electrical conductivity of a cathode having low electrical conductivity, and can increase the efficiency of an electrochemical reaction by improving the flow of air conducted to the cathode.

For example, the length of the unit cell 10 may be no less than 50 cm, and the cross-section of the unit cell 10 may be a circle. Since relatively high current flows in the large-sized unit cell having a length of no less than 50 cm, the voltage drop is also increased. On the other hand, the SOFC 100 according to this embodiment uses the present current collecting member 110. Thus, the movement of current between the unit cells 10 is enhanced even when the length of the unit cell 10 is no less than 50 cm, thereby preventing the voltage drop.

The current collecting member 110 may act as a path along which current (or electric charges) of adjacent unit cells 10 moves. The current collecting member 110 is composed of one or more layers 110a and 110b, and the layers 110a and 110b may be provided to have different voids from each other. For example, the first electrode 11 may include an anode, and the second electrode 12 may include a cathode. The current collecting member 110 may be provided with a layer having a low pore number per inch (ppi) at a portion of the current collecting member 110 contacting the second electrode 13 that is the cathode.

The ppi is a unit that represents the degree of pores of the current collecting member 110, and refers to the degree of pores formed on a 1-inch straight line. Specifically, the size of pores of the current collecting member 110 may be measured using an optical microscope and an image analyzer. That is, pores existing in 1 inch may be observed using the optical microscope, and the number and length of the pores observed using the optical microscope may be measured using the image analyzer. In this case, the size of the pores is obtained by measuring at least 10 portions of the current collecting member 110 and then averaging the measured values. The value of ppi is obtained by converting the measured number of the pores into a percentage (%) value for 1 inch.

The current collecting member provided to an outer circumferential surface of a cylindrical unit cell may be provided in the form of a foam so as to increase the contact area of the current collecting member with the unit cell. The current collecting member provided in the form of the foam has its increased contact area with the unit cell, and thus the collection area of current is broadened by the current collecting member. On the other hand, if the contact area is increased, the amount of oxygen that can flow into the second electrode, e.g., the cathode is decreased, and therefore, the efficiency of the SOFC is decreased. The SOFC according to the present invention increases the contact area with the unit cell using the current collecting member provided in the form of the foam, and also uses the embodied current collecting member so as to increase the amount of current that can flow into the cathode.

Also, the current collecting member 110 is composed of first and second current collecting layers 110a and 110b, and the first and second current collecting layers 110a and 110b may be provided to have different voids from each other. In the current collecting member 110, the first current collecting layer 110a that is a portion contacting the second electrode 13 is provided to have a lower ppi than the second current collecting member 110b, so that it is possible to increase the amount of oxygen that can flow into the second electrode 13, e.g., the cathode, thereby reducing or minimizing the voltage drop.

FIG. 4 is a graph showing voltage drop according to ppi and current. FIG. 5 is a graph showing air permeability according to ppi. FIGS. 4 and 5 shows results obtained by using a current collecting member having uniform voids so as to identify properties of the current collecting member according to the ppi of the current collecting member.

Referring to FIG. 4, the voltage drop of the current collecting member according to the ppi was observed by changing the ppi of the current collecting member into 10%, 20% and 40% and measuring current and voltage of the unit cell. It can be seen that in a case where the ppi of the current collecting member is 10%, a voltage drop of about 0.2V occurs when the current of the unit cell is 1 A, and a voltage drop of about 0.4V occurs when the current of the unit cell is 2.4 A. On the other hand, it can be seen that in a case where the ppi of the current collecting member is no less than 20%, a voltage drop of about 0.4V occurs when the current of the unit cell is 6.6 A. Therefore, when considering only the voltage drop, the ppi of the current collecting member is preferably no less than 20%.

Referring to FIG. 5, the air permeability according to the ppi of the current collecting member will be described. It can be seen that the air permeability is 90% when the ppi of the current collecting member is 20%, and the air permeability is 20% when the ppi of the current collecting member is 60%. That is, it can be seen that as the ppi of the current collecting member is increased, the air permeability is decreased. In the cathode such as the second electrode, the air permeability is important for the purpose of the flow of gas. On the other hand, as also shown in FIG. 5, the air permeability is rapidly decreased as the PPI is increased from when the ppi of the current collecting member's at 20%. In a case where the ppi of the current collecting member exceeds 60%, the air is hardly penetrated into the current collecting member, and therefore, it is difficult to use the current collecting member as a current collecting member of the second electrode.

Therefore, when considering both the voltage drop and air permeability, the current collecting member according to the present invention is preferably provided so that the ppi of the current collecting member is from 20 to 60%, and the ppi of the first current collecting layer directly contacting the second electrode is lower than that of the second current collecting layer.

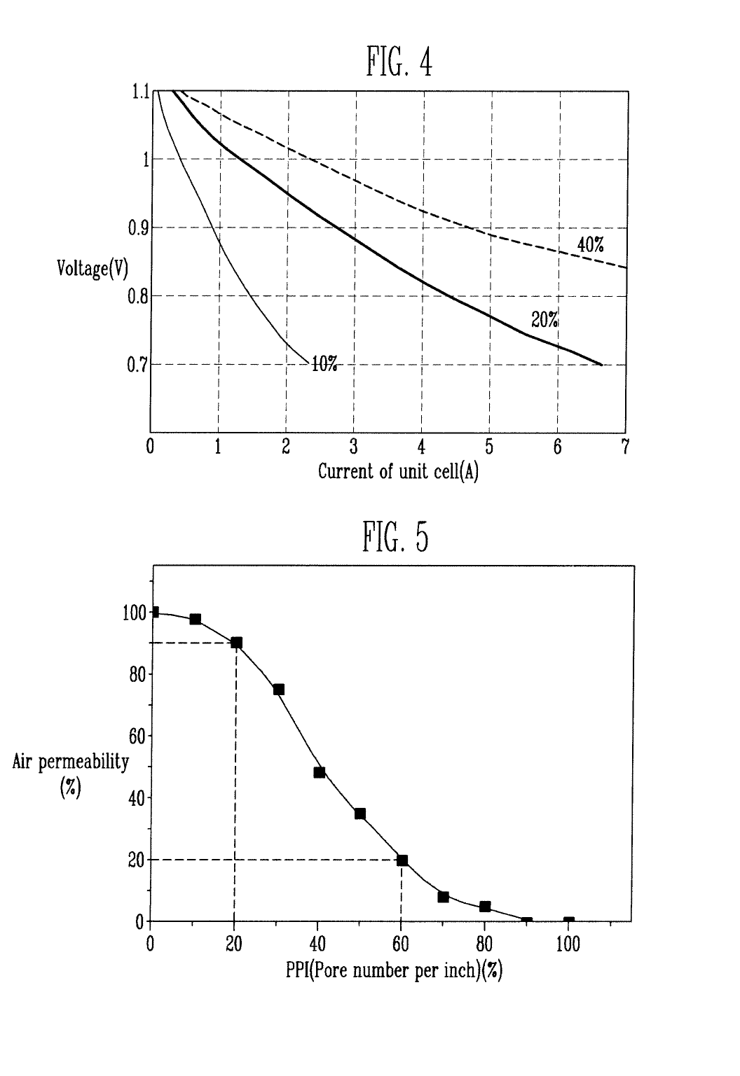

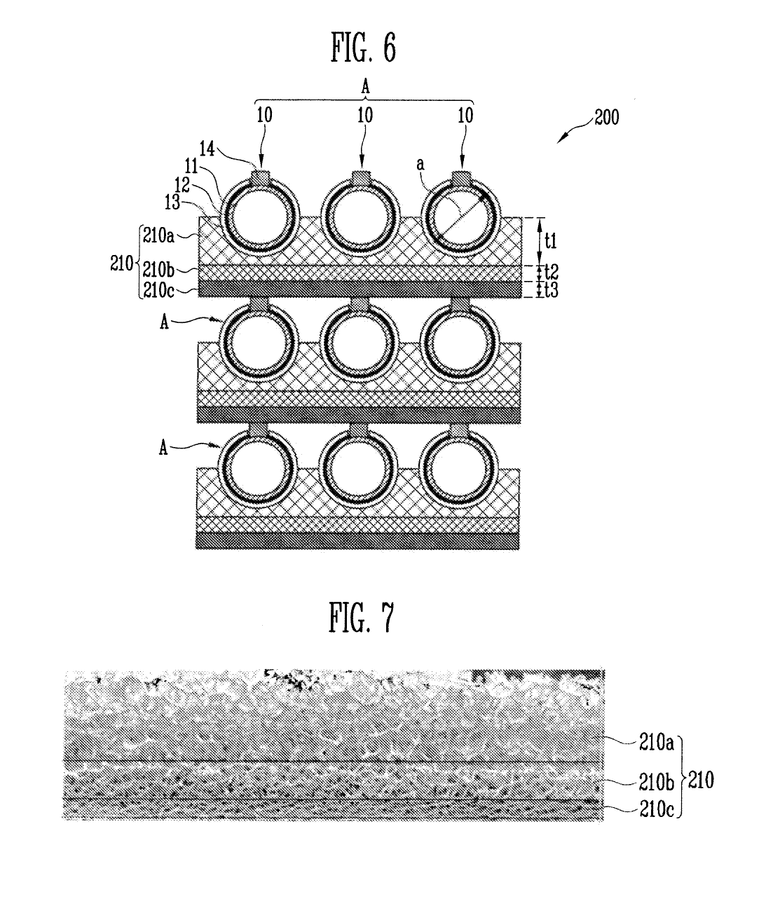

Hereinafter, another embodiment of the present invention will be described with reference to FIGS. 6 and 7. Contents of this embodiment, except the following detailed described contents, are similar to those of the embodiment described in FIGS. 1 to 5, and therefore, its detailed descriptions will be omitted.

FIG. 6 is a sectional view of an SOFC according to another embodiment of the present invention. FIG. 7 is an SEM photograph of a current collecting member of FIG. 6.

Referring to FIGS. 6 and 7, in the SOFC 200 according to this embodiment, a plurality of cylindrical unit cells 10 may be electrically connected by current collecting members 210. The unit cells 10 may be composed of first groups A each including one or more unit cells 10 arranged in parallel in a first direction, and the first groups A may be stacked to form a plurality of layers. The current collecting member 210 may be interposed between the plurality of layers.

The current collecting member 210 includes first to third current collecting layers 210a, 210b and 210c which are sequentially laminated, and the first current collecting layer 210a may be provided to contact the second electrode 13. The ppi of the first current collecting layer 210a may be no less than 20% to less than 30%. The ppi of the second current collecting layer 210b may be no less than 30% to less than 50%. The ppi of the third current collecting layer 210c may be no less than 50% to no more than 60%.

The first current collecting layer 210a of the current collecting member 210 is a portion that comes in direct contact with the second electrode 13. Therefore, in a case where the ppi of the first current collecting layer 210a is less than 20%, there may be a problem when current (or electrons) moves. In a case where the ppi of the first current collecting layer 210a is no less than 30%, it is difficult to allow air to flow into the second electrode 13. The second current collecting layer 210b may be provided between the first and third current collecting layers 210a and 210c. In a case where the ppi of the second current collecting layer 210b is less than 30%, the efficiency of the SOFC may be decreased. In a case where the ppi of the second current collecting layer 210b is no less than 50%, the flow of fluid in the current collecting member 210 is not actively performed, and therefore, the speed at which the air flows into the second electrode 13 may be decreased. The third current collecting layer 210c is a portion that contacts the interconnector 14 of an adjacent unit cell 10, and the movement of the current (or electrons) is particularly important in the third current collecting layer 210c. In a case where the ppi of the third current collecting layer 210c is less than 50%, the movement of current may be problematic. In a case where the ppi of the third current collecting layer 210c exceeds 60%, the air permeability according to the ppi of the third current collecting layer 210c is low, and therefore, the supply of air to the second electrode 13 may be problematic. Therefore, the ppi of the first current collecting layer 210a is preferably no less than 20% to less than 30%. The ppi of the second current collecting layer 210b is preferably no less than 30% to less than 50%. The ppi of the third current collecting layer 210c is preferably no less than 50% to no more than 60%. In addition, it is effective that the current collecting member 210 is provided so that the first to third current collecting layers 210a, 210b and 210c have different ppis from one another and the differences in ppi between the respective current collecting layers are equal to one another. Particularly, in the current collecting layer 210, the ppi of the first current collecting layer 210a is preferably 20%, the ppi of the second current collecting layer 210b is preferably 40%, and the ppi of the third current collecting layer 210c is preferably 60%.

The first to third current collecting layers 210a, 210b and 210c in the current collecting member 210 may be determined by the size of the unit cell 10. For example, with respect to the external diameter a of the unit cell, the thickness t1 of the first current collecting layer may be 0.5a to 1.2a, the thickness t2 of the second current collecting layer may be 0.1a to 0.5a, and the thickness t3 of the third current collecting layer may be 0.1a to 0.5a.

In a case where the thickness t1 of the first current collecting layer is less than 0.5 time (0.5a) with respect to the external diameter a of the unit cell, the contact area between the first current collecting layer 210a and the unit cell 10 is not sufficient, and therefore, the current collection efficiency of the SOFC may be deteriorated. In a case where the thickness t1 of the first current collecting layer exceeds 1.2 times (1.2a) with respect to the external diameter a of the unit cell, the size of the SOFC 200 may be increased by increasing the entire volume of the current collecting member 210. In a case where the thickness t2 of the second current collecting layer is less than 0.1 time (0.1a) with respect to the external diameter a of the unit cell, the area occupied by the second current collecting layer is not sufficient, and therefore, the movement of fluid between the first and third current collecting layers 210a and 210c may not be actively performed. In a case where the thickness t2 of the second current collecting layer exceeds 0.5 time (0.5a) with respect to the external diameter a of the unit cell, the current collection efficiency of current (or electrons) may be deteriorated. In a case where the thickness t3 of the third current collecting layer is less than 0.1 time (0.1a) with respect to the external diameter a of the unit cell, the current collecting member 210 does not have rigidity sufficient to support the unit cell 10, and further, a problem may occur in that adjacent stacked unit cells 10 come in direct contact with each other. In a case where the thickness t3 of the third current collecting layer exceeds 0.5 time (0.5a) with respect to the external diameter a of the unit cell, the contact resistance between the third current collecting layer and the unit cell is increased, and therefore, the efficiency of the SOFC may be deteriorated.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A solid oxide fuel cell (SOFC), comprising:
a plurality of cylindrical unit cells each having a first electrode, a second electrode provided to an outside of the second electrode, and an electrolyte interposed between the first and second electrodes; and
a current collecting member electrically connecting the unit cells,
wherein the current collecting member is composed of a plurality of layers, and the layers have different voids from one another.

2. The SOFC according to claim 1, wherein the unit cells are composed of first groups each having one or more of the unit cells arranged in parallel in a first direction, and the first groups are stacked to form a plurality of layers.

3. The SOFC according to claim 2, wherein the current collecting member is interposed between adjacent ones of the first groups in the plurality of layers.

4. The SOFC according to claim 1, wherein the layers of the current collecting member comprise a lowest pore number per inch (ppi) layer at a portion of the current collecting member contacting the second electrode.

5. The SOFC according to claim 1, wherein the pore number per inch (ppi) of the current collecting member is 20 to 60%.

6. The SOFC according to claim 1, wherein the layers of the current collecting member comprise first, second, and third current collecting layers which are sequentially laminated, and the first current collecting layer is provided to come in contact with the second electrode.

7. The SOFC according to claim 6, wherein the pore number per inch (ppi) of the first current collecting layer is no less than 20% to less than 30%, the ppi of the second current collecting layer is no less than 30% to less than 50%, and the ppi of the third current collecting layer is no less than 50% to no more than 60%.

8. The SOFC according to claim 6, wherein, with respect to the external diameter a of the unit cell, the thickness of the first current collecting layer is 0.5a to 1.2a, the thickness of the second current collecting layer is 1.0a to 0.5a, and the thickness of the third current collecting layer is 0.1a to 0.5a.

9. The SOFC according to claim 1, wherein the layers of the current collecting member comprise a first layer and a second layer, the pore number per inch (ppi) of the first layer is lower than that of the second layer, and the first layer is at a portion of the current collecting member contacting the second electrode.

10. A solid oxide fuel cell (SOFC), comprising:
a first group of cylindrical unit cells each having a first electrode, a second electrode provided to an outside of the second electrode, and an electrolyte interposed between the first and second electrodes;
a second group of cylindrical unit cells each having a first electrode, a second electrode provided to an outside of the second electrode, and an electrolyte interposed between the first and second electrodes; and
a current collecting member electrically connecting the first group of cylindrical unit cells to the second group of cylindrical unit cells in series and electrically connecting the unit cells of the first group in parallel,
wherein the current collecting member is composed of a plurality of layers, and the layers have different voids from one another.

11. The SOFC according to claim 10, wherein the layers of the current collecting member comprise a lowest pore number per inch (ppi) layer at a portion of the current collecting member contacting the second electrodes of the unit cells of the first group.

12. The SOFC according to claim 10, further comprising an interconnector contacting the first electrodes of the units cells of the second group.

13. The SOFC according to claim 12, wherein the interconnector comprises a plurality of interconnectors.

14. The SOFC according to claim 12, wherein the layers of the current collecting member comprise a highest pore number per inch (ppi) layer at a portion of the current collecting member contacting the interconnector.

15. The SOFC according to claim 10, wherein the pore number per inch (ppi) of the current collecting member is 20 to 60%.

16. The SOFC according to claim 10, wherein the layers of the current collecting member comprise first, second, and third current collecting layers which are sequentially laminated, and the first current collecting layer is provided to come in contact with the second electrodes of the unit cells of the first group.

17. The SOFC according to claim 16, wherein the pore number per inch (ppi) of the first current collecting layer is no less than 20% to less than 30%, the ppi of the second current collecting layer is no less than 30% to less than 50%, and the ppi of the third current collecting layer is no less than 50% to no more than 60%.

18. The SOFC according to claim 16, wherein, with respect to the external diameter a of each of the unit cells, the thickness of the first current collecting layer is 0.5a to 1.2a, the thickness of the second current collecting layer is 1.0a to 0.5a, and the thickness of the third current collecting layer is 0.1a to 0.5a.

19. The SOFC according to claim 10, wherein the layers of the current collecting member comprise a first layer and a second layer, the pore number per inch (ppi) of the first layer is lower than that of the second layer, and the first layer is at a portion of the current collecting member contacting the second electrodes of the unit cells of the first group.

20. A solid oxide fuel cell (SOFC), comprising:
a first unit cell having a first electrode, a second electrode provided to an outside of the second electrode, and an electrolyte interposed between the first and second electrodes;
a second unit cell having a first electrode, a second electrode provided to an outside of the second electrode, and an electrolyte interposed between the first and second electrodes;
a current collecting member; and
an interconnector between the first electrode of the second unit cell and the current collecting member,
wherein:
the current collecting member is between the second electrode of the first unit cell and the interconnector,
the current collecting member is composed of a plurality of layers, and
the layers have different voids from one another.
